(19) United States
(12) Patent Application Publication
(10) Pub. No.: US 2014/0150003 A1
(43) Pub. Date: May 29, 2014

(54) METHODS AND APPARATUS TO CALCULATE A PROBABILITY OF INDEX CONSISTENCY

(71) Applicant: Peter Doe, Ridgewood, NJ (US)

(72) Inventor: Peter Doe, Ridgewood, NJ (US)

(21) Appl. No.: 13/795,493

(22) Filed: Mar. 12, 2013

Related U.S. Application Data
(60) Provisional application No. 61/730,735, filed on Nov. 28, 2012.

(51) Int. Cl. H04N 21/475

(52) U.S. Cl. CPC H04N 21/4756
USPC 725/9

(57) ABSTRACT

Methods, apparatus, systems and articles of manufacture are disclosed to calculate a probability of index consistency. An example method disclosed herein includes selecting a first benchmark audience rating and a first brand user rating, calculating a first ratio of the first benchmark audience rating and a first benchmark audience effective sample size, calculating a second ratio of the first brand user rating and a brand user effective sample size, calculating a standard error based on the first and second ratios and an index based on the first benchmark audience rating and the first brand user rating, and calculating a first consistency value based on the standard error.

### RELATED APPLICATION

This patent claims priority to U.S. Application Ser. No. 61/730,735, which was filed on Nov. 28, 2012 and is hereby incorporated herein by reference in its entirety.

### FIELD OF THE DISCLOSURE

This disclosure relates generally to market research, and, more particularly, to methods and apparatus to calculate a probability of index consistency.

### BACKGROUND

In recent years, market researchers have employed product databases that include demographic indicators. Demographic indicators associated with past product performance include gender, age and/or indicators associated with household income. To reach consumers that fall within and/or otherwise reflect certain demographic indicators, market researchers select media with which to associate one or more advertisements.

Media (e.g., media vehicles) that the market researchers may choose when exposing consumers to an advertisement include, but are not limited to television programs, radio programs, Internet websites and/or print media (e.g., magazine, newspaper, etc.). Some channels within each media may have greater or lesser exposure to one or more demographic indicators of interest to the media researchers.

### BRIEF DESCRIPTION OF THE DRAWINGS

FIG. 1A is a table including an example marketing initiative for a first period.

FIG. 1B is a table of the marketing initiative of FIG. 1A including results for a second period.

FIG. 2 is a schematic illustration of an example consistency evaluator constructed in accordance with the teachings of this disclosure to calculate a probability of index consistency.

FIG. 3 is a chart showing a comparison between an example detailed standard error calculation and an example simplified error calculation.

FIG. 4 is a heatmap showing example design effect tables of consistency probability.

FIG. 5 is a heatmap showing example design effect tables of index consistency.

FIG. 6 is a heatmap showing example design effect tables of standard error.

FIG. 7 is a flowchart representative of example machine readable instructions which may be executed to calculate a probability of index consistency.

FIG. 8 is a schematic illustration of an example processor platform that may execute the instructions of FIG. 7 to implement the example consistency evaluator of FIG. 2.

### DETAILED DESCRIPTION

Market researchers, media planners and/or sellers (hereinafter referred to generally as market researchers) have employed demographic-based performance data to decide how to focus advertising efforts intended to reach audiences of interest. In some examples, the market researchers utilize databases that go beyond standard demographics and include “brand users.” For example, a manufacturer of razor products may utilize consumer behavior databases that focus on men of age 18-34 as a demographic group most likely to purchase razor products. On the other hand, product use databases of men age 18-34 that are also known to be current or past razor buyers will result in a marketing focus that targets potential consumers having a greater propensity to purchase razor products.

While using one or more focused brand databases is believed to provide a market researcher a better return on invested advertising dollars, the sample size of men 18-34 (e.g., a standard demographic database) is larger than the sample size of men 18-34 that are also confirmed razor buyers (e.g., a brand-focused database). As a result, a corresponding statistical reliability for the brand-focused database is lower than the statistical reliability for the standard demographic database because, in part, the sample size of the brand-focused database is smaller than the sample size of the standard demographic database. Generally speaking, a statistical reliability refers to a sampling error associated with a dataset. For example, a first period of consumer purchase data may indicate particular television shows that score particularly well for a marketing objective. However, a second (e.g., a subsequent) period may not result in consistent scores for those same television shows. On the other hand, the second (e.g., the subsequent) period may result in surprisingly good scores, but in either case the statistical repeatability between the first period and the second period cannot be trusted as a reliable indicator on how to strategize marketing efforts for a third (subsequent) period. As used herein, consistency reflects a similarity of dataset results over at least two periods of evaluation (e.g., two time periods). Results that are not consistent (inconsistent) between periods may be caused by actual change to behaviors of the dataset, statistical fluctuations, or a combination of both.

Market researchers may identify a proportion of a population from a set of consumer behavior data that performs some activity of interest (e.g., product purchase, vote, etc.). For an example dataset, if 5% of a sample size of 500 people buy a particular razor of interest, then the standard error may be calculated in a manner consistent with example Equation 1.

$$S . E . = \sqrt{\frac{( p ) ( q )}{n}} . \qquad Equation 1$$

In the illustrated example of Equation 1, S.E. refers to the standard error, p reflects a proportion of a population that does the activity of interest, q refers to the difference between p and a whole population (q=1−p), and n reflects a sample size of the population. Continuing with the example above, the standard error associated with 5% of a population of 500 people performing an action is 0.97, which reflects a measure of reliability in connection with a confidence interval of interest. Generally speaking, a confidence interval includes a value or a range of values indicative of a reliability of one or more estimates, such as an indication of how reliable survey results are. In these circumstances, a 95% statistical confidence interval can be obtained by multiplying the standard error by 1.96 (a figure readily obtained from normal distribution probability tables), which in this example would yield a confidence interval of 1.90. Accordingly, while 5% of the population was believed to perform a particular activity, such belief is associated with a 95% confidence of plus or minus 1.90. In other words, the research suggests that the true population figure has a 95% likelihood of being between 3.1% (i.e., 5%-1.90%) and 6.9% (i.e., 5%+1.90%), and a 5% likelihood of residing outside the range of 3.1% to 6.9%.

In the illustrated example above, the margin of error may be considered acceptable for an intended purpose, but in other examples the margin of error may reflect a more dramatic range of possibilities. Consider television viewership behavior data related to an example demographic of interest for men having ages 18-24, and television viewership behavior data related to an example demographic of men 18-24 that are also razor buyers (e.g., a brand-focused demographic). The corresponding rating values may be, in this example, 4 and 6, which correspond to the rating values for razor buyers and the benchmark audience of men 18-24, respectively. Rating values may include data indicative of a behavior and/or occurrence of interest, in which larger values typically reflect a relatively greater degree of the observed behavior and/or occurrence of interest. In some examples, rating values include television viewership activity (e.g., a reflection of a number of people watching a television program). Market researchers typically calculate a brand user index value based on rating values to identify a relative strength of a candidate choice. In the example above, the brand user index is 67 (i.e., 4/6*100). The market researcher may compare the resulting brand user index to one or more other (e.g., previous) marketing initiatives performed to appreciate whether success is likely to occur. However, a single datapoint may not reveal the range of possibilities in connection with a margin of error associated with either the benchmark rating (i.e., the demographic of men ages 18-24), the target rating (i.e., the demographic of men ages 18-24 that are also razor buyers), or both.

The television viewership behavior for this benchmark audience may have a corresponding rating value with a margin of error. For example, while the example datapoint above for the benchmark rating for men 18-24 was 6, the possible range of ratings may reside between values of 4 and 8. Also consider example television viewership behavior data related to an example demographic of interest for men having ages 18-24 that are also known razor buyers. While the example datapoint above for the target rating for men 18-24 that are also razor buyers was 4, the possible range of ratings may reside between values of 2 and 6 when considering margins of error. As described above, based on the example data, brand user index values may be calculated to provide a relative strength of each brand. Four corresponding brand user index values in view of the above example data are shown in example Table 1 below.

TABLE 1

| | Abs. | | | Abs. |
|---|---|---|---|---|
| | Min. | | | Max. |
| Brand User Rating | 2 | 2 | 6 | 6 |
| Benchmark Rating | 8 | 4 | 8 | 4 |
| Brand User Index | 25 | 50 | 75 | 150 |

In the illustrated example Table 1, the lowest possible brand user index corresponds to a lowest rating (i.e., absolute minimum) for the brand user (i.e., 2) and a highest rating (i.e., absolute maximum) for the benchmark (i.e., 8), resulting in an index value of 25 (i.e., 2/8×100). On the other hand, the highest possible brand user index corresponds to a highest rating for the brand user (i.e., 6) and a lowest rating for the benchmark (i.e., 4), resulting in an index value of 150. Considering the example single datapoint above having a target rating of 67, the example range between 25 and 150 in view of possible margins of error is not deemed to be actionable by a market researcher to garner confidence that a choice to select a particular brand user for a marketing campaign (e.g., a particular television show that has known razor buyers that are male and between the ages of 18 and 24). In other words, the single datapoint calculated above to yield a brand index rating of 67 is not actionable when the possibilities of actual index values can range from 25 to 150.

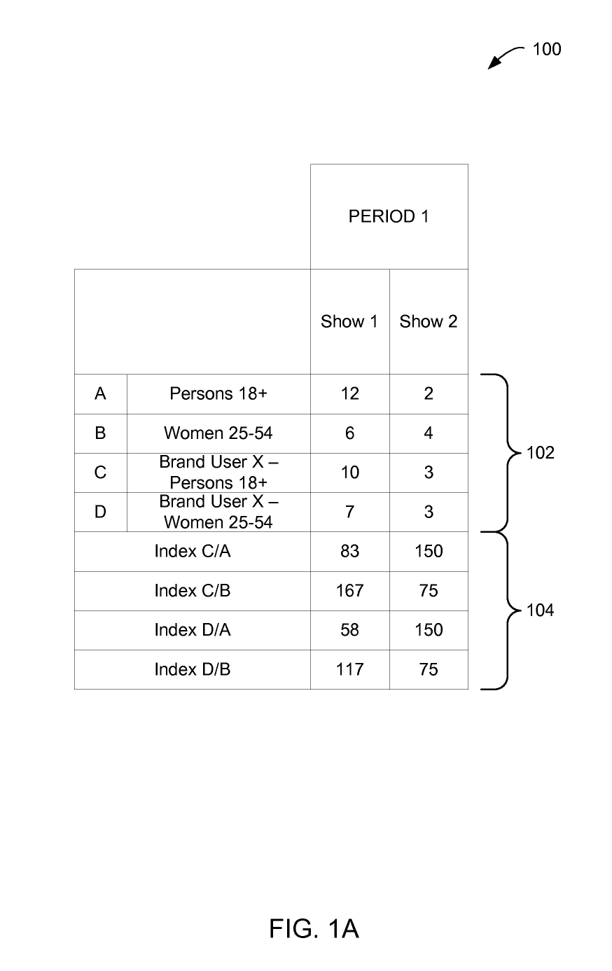

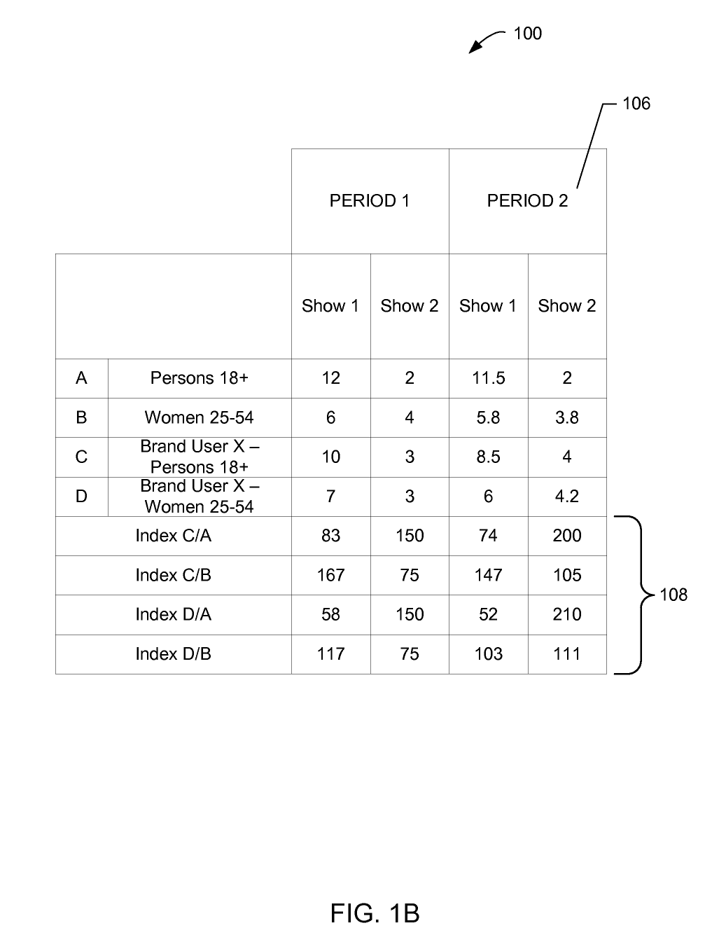

To illustrate a manner in which market researchers may rely on ratings estimates prematurely, FIG. 1A illustrates a table 100 associated with an example marketing initiative in which two television shows (Show 1 and Show 2) may be selected for further marketing efforts for a target brand during a first period (Period 1). The example target brand may be any type of service and/or product of interest to the market researcher. In the illustrated example of FIG. 1A, average ratings estimates (rating values) 102 are shown for each of Show 1 and Show 2 during the first period. The example ratings estimates may be obtained from any type of data source including, but not limited to television ratings data, demographics data and/or classification data, such as example data cultivated by The Nielsen Company. To identify relative strengths of Show 1 or Show 2 in view of particular brand user groups (e.g., Brand User X for persons 18 and older, Brand User X for women of ages 25 to 54, etc.), brand index values 104 are calculated. The market researcher may employ several strategies with which to proceed with a marketing initiative. Assume that the brand user for the market researcher is Brand User X for women ages 25-54. The market researcher could review the target ratings at mere face value to proceed based on the relative strength of Show 1 (rating estimate=7) instead of Show 2 (rating estimate=3). Alternatively, the market researcher may identify that the relative strength of Show 2 is greater than the strength of Show 1 based on the D/A index (Show 1 index=58, Show 2 index=150). On the other hand, Show 2 appears weaker than Show 1 based on the D/B index (Show 1 index=117, Show 2 index=75).

The market researcher may look to other information in an effort to decide which of Show 1 or Show 2 is a better choice for marketing investment resources for a subsequent period (e.g., Period 2). If the market researcher is particularly focused on targeting women aged 25 to 54 and, for example, advertising costs of Show 1 yield a larger gross rating point (GRP), then the market researcher may decide to proceed with Show 1 (index=117) in the subsequent period of marketing efforts. Generally speaking, the GRP is a measure of the size of an audience reached by a specific media vehicle or schedule. In moving ahead with this example decision to invest marketing resources in Show 1 rather than Show 2, the market researcher typically expects that performance in the subsequent period will be similar to that observed in the first period (e.g., an expectation of consistent behavior between periods), which served as the only basis for the decision to proceed with Show 1. However, after the decision is made and the subsequent period begins and/or otherwise completes, the previous decision can be reviewed in light of empirical data. FIG. 1B builds upon the example Period 1 of FIG. 1A and includes observed behavior data for Period 2.

In the illustrated example of FIG. 1B, average ratings estimates for Period 2 (106) are added and corresponding brand user values (108) are calculated. During Period 2, behaviors of Persons 18+ and Women 25-54 remained relatively consistent, but corresponding brand user ratings were relatively less predictable. In particular, the brand user by demographic index (D/B) shifted such that Show 1 is still positive for its corresponding brand user, but Show 2 has switched from being negative (e.g., less than an index value of 100) to positive (e.g., greater than an index value of 100). In other words, this example illustrates a lack of consistency in expectations, and that Show 2 may have been a better decision when expending marketing resources in Period 2. Similarly, the D/A index also illustrates a lack of consistency from Period 1 to Period 2, and that Show 2 performed relatively better than Show 1 in Period 2.

Example methods, apparatus, systems and/or articles of manufacture disclosed herein calculate a probability of index consistency. In some examples, example methods, apparatus, systems and/or articles of manufacture disclosed herein identify the probability that an index value of 100 or lower will stay below 100 in the future so that one or more marketing initiatives can be selected and/or otherwise ranked to improve marketing investment expenditures.

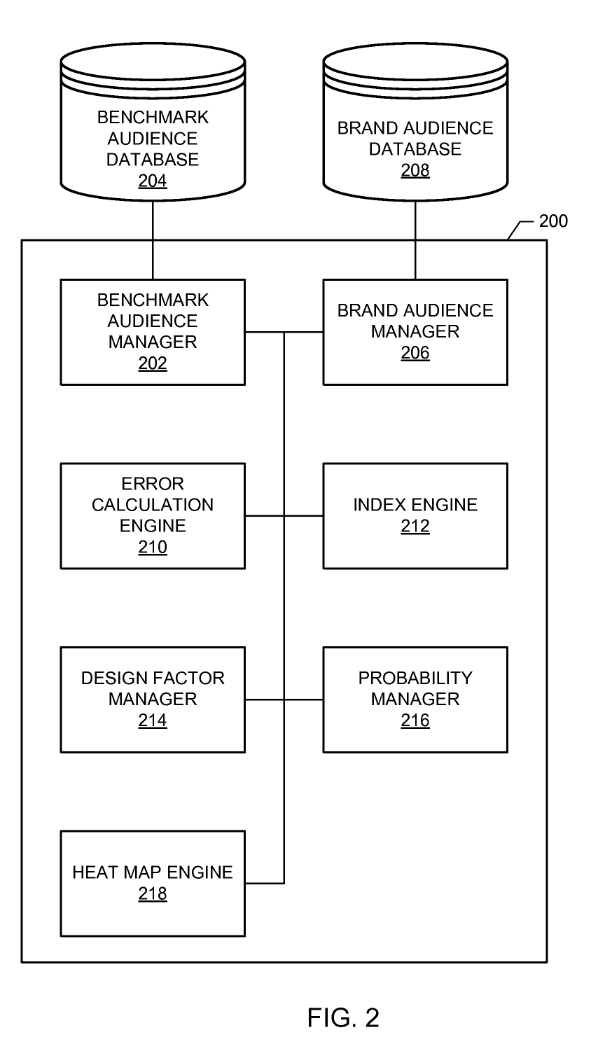

FIG. 2 is a schematic illustration of an example consistency evaluator 200 to calculate a probability of index consistency. In the illustrated example of FIG. 2, the consistency evaluator 200 includes a benchmark audience manager 202 communicatively connected to a benchmark audience database 204, a brand audience manager 206 communicatively connected to a brand audience database 208, an error calculation engine 210, an index engine 212, a design factor manager 214, a probability manager 216 and a heat map engine 218.

In operation, the example benchmark audience manager 202 identifies an audience of interest and corresponding target ratings (e.g., numeric values indicative of behavior and/or performance). Example target ratings may reflect survey data, panelist data and/or any other data indicative of consumer activity that is associated with one or more demographic categories of interest. The example brand audience manager 206 identifies a brand of interest and corresponding brand user ratings (e.g., numeric values indicative of behavior and/or performance). As described above, benchmark audience ratings and/or brand user ratings may be received and/or otherwise retrieved from the example benchmark audience database 204 and the example brand audience database 208. Such databases may further reflect information cultivated by market research organizations (e.g., The Nielsen Company) and/or other marketing efforts related to consumer behavior. Data associated with the example benchmark audience database 204 is associated with a corresponding effective sample size (n), and data associated with the example brand user audience database 208 is associated with a corresponding effective sample size (m).

The example error calculation engine 210 calculates a ratio of the benchmark target rating to its corresponding sample size in a manner consistent with example Equation 2.

$$\frac{{p}_{1} ( 1 - {p}_{1} )}{n} . \qquad Equation 2$$

In the illustrated example of Equation 2, p₁ reflects the benchmark rating and n reflects a corresponding sample size of the benchmark rating. The example error calculation engine 210 also calculates a ratio of the brand user rating to its corresponding sample size in a manner consistent with example Equation 3.

$$\frac{{p}_{2} ( 1 - {p}_{2} )}{m} . \qquad Equation 3$$

In the illustrated example of Equation 3, p₂ reflects the brand rating and m reflects a corresponding sample size of the brand rating p₂. The example error calculation engine 210 calculates a standard error S of the difference between the benchmark rating (p₁) and the brand rating (p₂) in a manner consistent with example Equation 4.

$$S = \sqrt{\frac{{p}_{1} ( 1 - {p}_{1} )}{n} + \frac{{p}_{2} ( 1 - {p}_{2} )}{m}} . \qquad Equation 4$$

Example Equation 4 may be reformatted in a manner that considers a ratio of the brand rating (p₂) and the benchmark rating (p₁) as variable k (k=p₂/p₁), and a ratio of the benchmark effective sample size (n) and the brand effective sample size (m) as variable c (c=n/m). Considering ratio variables k and c, example Equation 4 is reformatted as example Equation 5:

$$S = \sqrt{\frac{{p}_{1} ( 1 + ck ) - {p}_{1}^{2} ( 1 - {ck}^{2} )}{c m}} . \qquad Equation 5$$

In some examples, Equation 5 may be further simplified without a loss of accuracy when calculating the standard error S. Example Equation 5 may be rewritten in a manner consistent with example Equation 6.

$$S ≅ \sqrt{\frac{{p}_{1} k}{m}} = \sqrt{\frac{{p}_{2}}{m}} . \qquad Equation 6$$

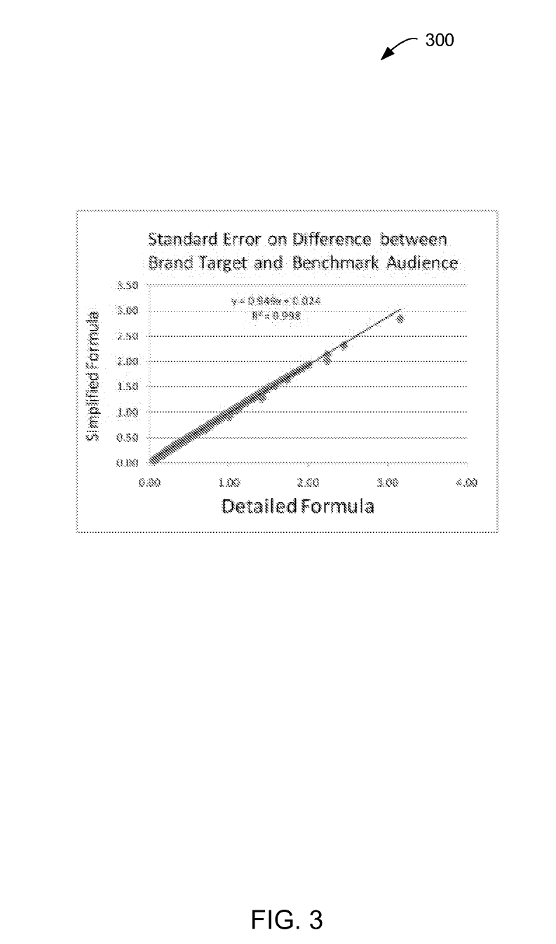

In the illustrated example of Equation 6, the closeness of the approximation tracks relatively closely to the more detailed calculation of the standard error (S) of example Equation 5. In particular, FIG. 3 illustrates a chart 300 plotting standard error (S) results using example Equation 5 and example Equation 6 for a combination of approximately 330 scenarios. In the illustrated example of FIG. 3, the example scenarios consider target penetrations of 1%, 2%, 5%, 10% and 20%, benchmark audience values p₁ form the set {0.1, 0.5, 1, 2, 3, 5}, and brand index values p₂ form the set {70, 80, 90, 100, 100, 120, 130, 140, 150, 200, 400}. As shown in the illustrated example of FIG. 3, the simplified version of example Equation 6 tracks closely to the relatively more detailed example of Equation 5.

While an assumption of sample independence can be made without negative effects to the closeness of approximation, one or more design effects can be applied to identify and/or otherwise appreciate how differences in sample size, variation, the use of averaged vehicles, and/or clustering affect the calculation(s). One or more design effect values (d) are applied to the standard error calculation in a manner consistent with example Equation 7.

$$S ≅ d \sqrt{\frac{{p}_{2}}{m}} . \qquad Equation 7$$

Generally speaking, consistency is typically better for relatively shorter intervals, and benchmark demographic datasets are relatively less consistent than brand user datasets. At least one reason for the consistency differences between benchmark data and brand user data is that benchmark data includes a focus on a demographic type absent consideration for any other behavior propensity. As such, brand user data is sometimes interlaced with benchmark demographics data, and the degree of interlacing may be reflected in one or more values of the design effect (d). Some index levels will indicate greater or lesser differences in the standard error. To identify differences in view of a statistical significance level, such as a 95% significance level for a one tailed test distribution, a condition consistent with example Equation 8 may be used.

$$zd \sqrt{\frac{{p}_{2}}{m} < {p}_{2} - {p}_{2 }} . \qquad Equation 8$$

In the illustrated example of Equation 8, p₂ reflects the mathematical product of k and p₁, k reflects the index divided by 100, m reflects the brand user effective sample size, d reflects the design effect, and z reflects a significance value. The significance value is based on the significance level of interest and whether a one-tailed or two tailed distribution is evaluated. For example, the example probability manager 214 identifies an example one-tailed test having a 95% significance level to calculate and/or otherwise generate a corresponding significance value of 1.645.

The example probability manager 214 solves for the index (k), the standard error (S), or the significance value (z) depending on the type of analysis output of interest. To generate one of the index (k), the standard error (S), or the significance value (z), the example probability manager 216 sets example Equation 8 to equality to derive a minimum index required for a particular significance in a manner consistent with example Equation 9.

$$zd \sqrt{\frac{{kp}_{1}}{m}} = {p}_{1} \vert k - 1 \vert . \qquad Equation 9$$

In the event the significance value is to be calculated, the example probability manager 216 solves example Equation 9 for z as shown below in example Equations 10 and 11.

$$\begin{matrix}z = \pm \frac{( k - 1 )}{dk} \sqrt{{kmp}_{1}} . & Equation 10 \\ z = \pm \frac{( k - 1 )}{dk} \sqrt{m {p}_{2}} . & Equation 11\end{matrix}$$

Applying example Equation 11 to an example scenario, assume a brand user rating (p₂) of 0.33, a benchmark rating (p₁) of 0.52, an index (k) of 63, and a design effect (d) of 0.51. The resulting significance value (z) is calculated by the example probability manager 216 to yield a value of 4.4. Using standard statistical tables for a 95% confidence interval, the z-score of 4.4 results in being significant at a level of 99.995%, which may be interpreted to reflect that results in a second period will be consistent.

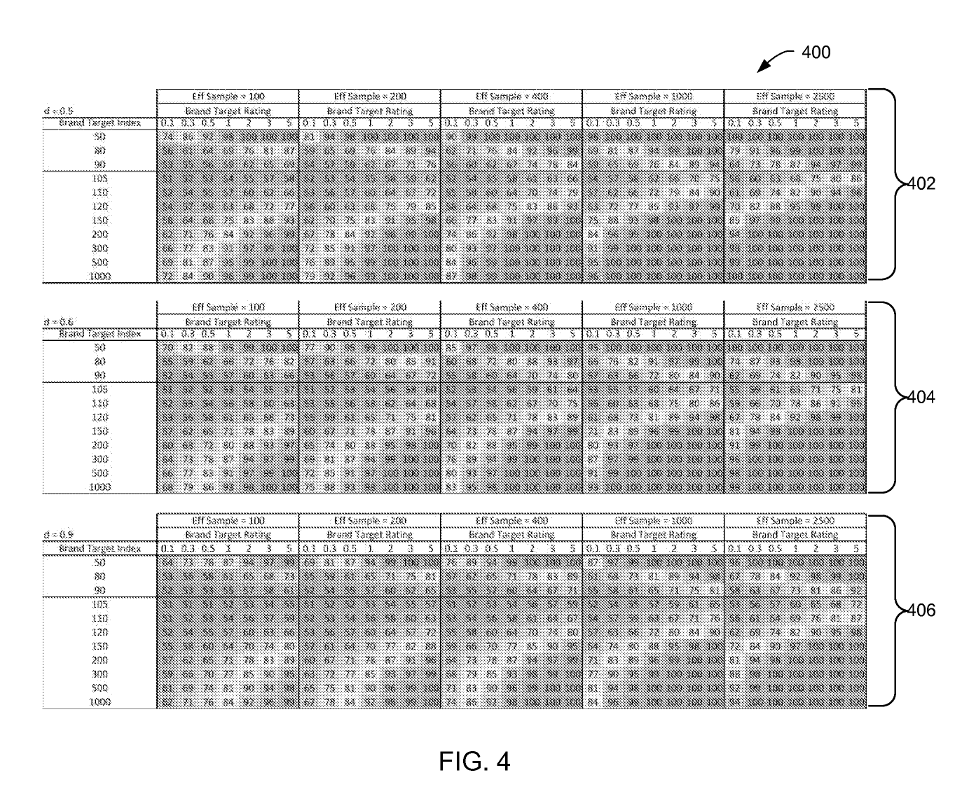

The example probability manager 216 converts one or more significance values to corresponding probability indicator values to determine a statistical significance based on the selected benchmark audience data, brand data, design factor and effective sampling sizes. The resulting statistical significance is indicative of a percent chance that a brand user index is different from 100 in connection with one or more different scenarios of ratings values, index values, sample sizes and/or viewing events. The example heat map engine 218 generates a heat map for one or more probability indicator values in connection with one or more scenarios, as shown in FIG. 4. In the illustrated example of FIG. 4, a heat map 400 includes a first design effect table 402, a second design effect table 404 and a third design effect table 406. While the illustrated example heat map 400 includes three design effect tables (402, 404, 406), example methods, apparatus, systems and/or articles of manufacture disclosed herein are not limited thereto. Each example design effect table (402, 404, 406) may reflect differing design effect factors related to, for example, a number of episodes, a network by daypart rating and/or an interval duration of consistent brand user activity (e.g., three months, four to six months, etc.).

In the illustrated example of FIG. 4, the first design effect table 402 includes an example design effect value of 0.5, the second design effect table 404 includes an example design effect value of 0.6, and the third design effect table 406 includes an example design effect value of 0.9. Each value in the example heat map 400 is color coded based on one or more threshold values of a percentage chance that a brand user index is different from 100. As described above, each design effect is a multiplier that reflects different reliability levels related to different viewing scenarios and/or intervals. The color-coding thresholds in the illustrated example of FIG. 4 apply a color of green to indicate relatively more reliable percentage chance values (in view of a threshold), and apply a color of red to indicate relatively less reliable percentage chance values. Each of the example first, second and third design effect tables (402, 404, 406) result from calculations performed by the example probability manager 216 in a manner consistent with example Equation 11.

In connection with the one or more different analysis scenarios of interest, the example heat map 400 indicates a percentage chance that a brand user of interest will be different from a value of 100. For example, a brand user having an effective sample size of 400, a brand user rating of 2 that indexes at a value of 120 intersects a percentage chance value of 83%. In other words, the aforementioned example scenario corresponds to an 83% chance of being higher than 100, and is valid for circumstances having at least two aggregated program results (e.g., television episodes) for intervals up to three months in duration. However, in the event such circumstances differ, then one or more alternate design effect values (d) may be more appropriate, for which one or more additional and/or alternate design effect tables may be calculated by the example probability manager 216 and plotted by the example heat map engine 218. For example, in the event a brand user classification experiences a discontinuity in a relatively longer time period (e.g., due to a data update), then the example second design effect table 404 indicates a 78% chance of being higher than 100. In another example, circumstances in which single episodes of a show are used as the brand user, the example third design effect table 406 indicates a 70% chance of the index being higher than 100.

In the event the index is to be calculated, which allows the market researcher to determine which index values must be achieved to ensure a significant difference from 100 at one or more levels of significance, the example probability manager 216 solves example Equation 9 for k as shown below in example Equation 12.

$$k = \frac{2 m {p}_{1} + {z}^{2} {d}^{2} \pm zd \sqrt{4 m {p}_{1} + {z}^{2} {d}^{2}}}{2 m {p}_{1}} . \qquad Equation 12$$

Applying example Equation 12 to an example scenario, assume a brand user effective sample size (m) of 400, a benchmark audience (p₁) of 1 (0.01), a significance value (z) of 1.645 for a one-tailed test at a 95% significance level, and a design effect (d) of 0.6. The resulting index values are calculated by the example probability manager 216 to yield 0.61 or 1.64, which means that index values less than 61 or greater than 164 result in differences that are significant.

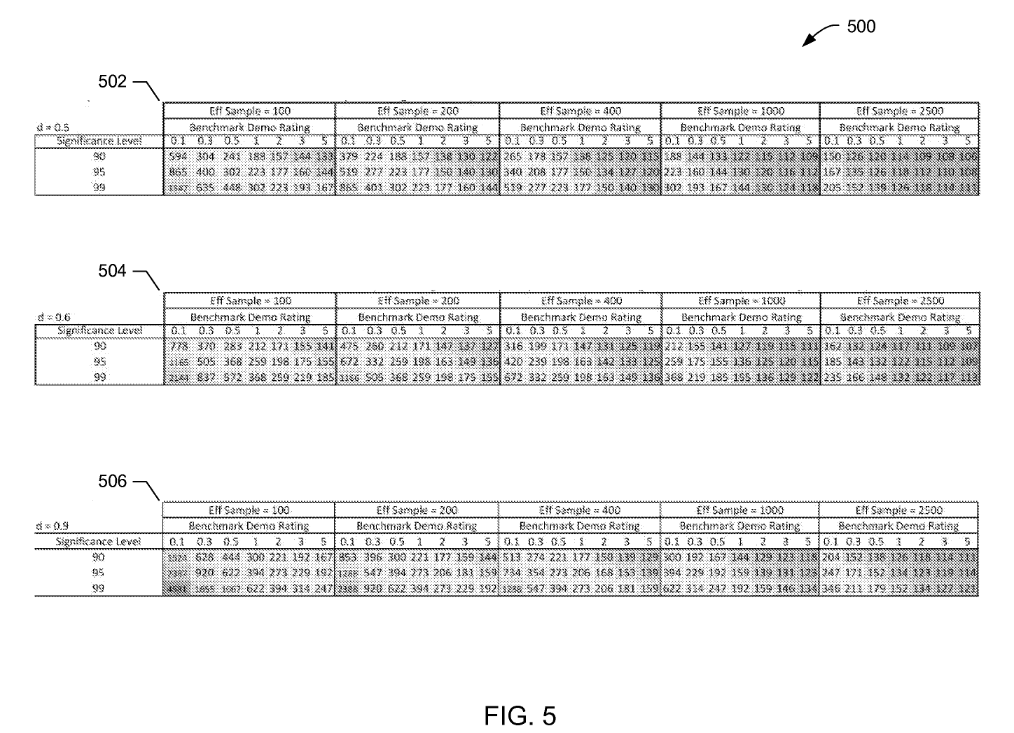

The example heat map engine 218 generates a heat map for one or more index values in connection with one or more scenarios, as shown in FIG. 5. In the illustrated example of FIG. 5, a heat map 500 is generated by the example heat map engine 218 based on values calculated by the example probability manager 216 in a manner consistent with example Equation 12. The values shown in the illustrated example of FIG. 5 indicate index values required to ensure a significant difference from 100 at one or more levels of significance given one or more different ratings levels and sample sizes. In the illustrated example of FIG. 5, a first design effect table 502, a second design effect table 504 and a third design effect table 506 reflect different design effect factor values (d). Additionally, for each of the first, second and third design effect tables 502, 504, 506, a corresponding 90%, 95% and 99% significance level is calculated by the example probability manager 216.

In the event the standard error is to be calculated for one or more confidence intervals (a 95% confidence interval is associated with a statistical constant of 1.96, a 99% confidence interval is associated with a statistical constant of 2.58, etc.), the example probability manager 216 solves for S as shown below in example Equation 13.

$$S ≅ \frac{dk}{\sqrt{m {p}_{2}}} . \qquad Equation 13$$

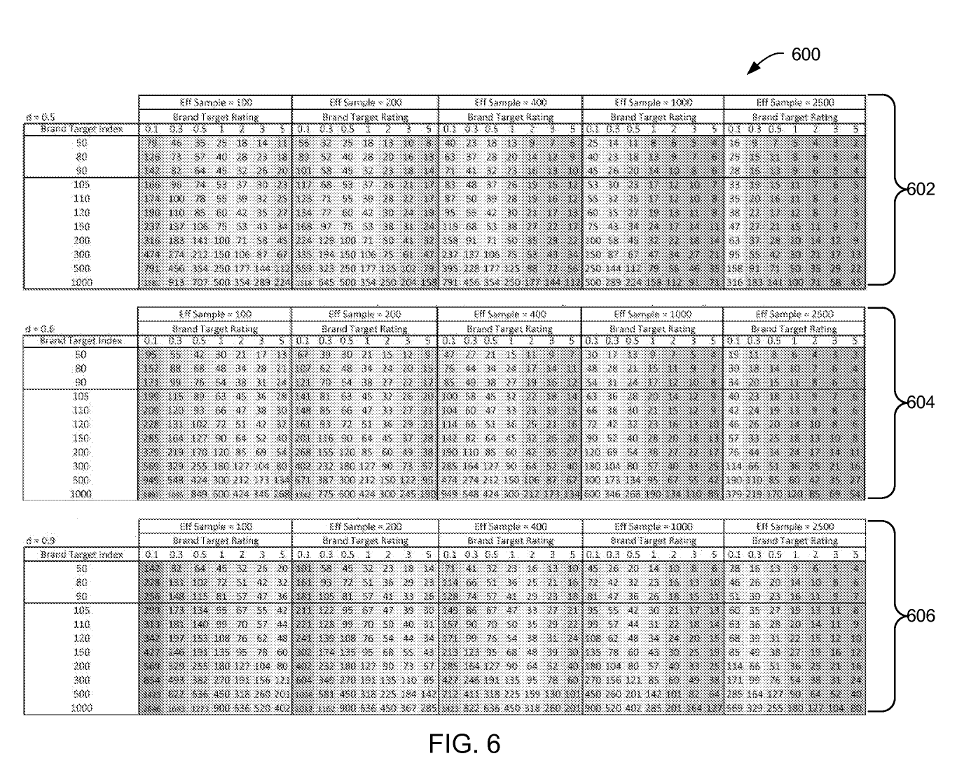

FIG. 6 illustrates an example heat map 600 generated by the example heat map engine 218, which includes calculated standard error values based on one or more combinations of the design effect value (d), brand user index, brand user rating and effective sample size. In the illustrated example of FIG. 6, the heat map 600 includes a first design effect table 602, a second design effect table 604 and a third design effect table 606 to reflect different scenarios and their corresponding reliability levels. As an example, for a sample size of 400, a rating value of 2 and an index value of 120 for scenarios associated with a design effect of 0.5 (e.g., design effect based on a television series have two or more episodes, a particular network by day-part rating and an interval of 3 months of consistent fusion donor data), a corresponding standard error is +/−21. Additionally, considering a margin of error at a 95% confidence interval yields a standard error range between values of 89 and 161 (e.g., 120+/−(1.96*21)).

While an example manner of implementing the consistency evaluator 200 of FIG. 2 is illustrated in FIGS. 2-6, one or more of the elements, processes and/or devices illustrated in FIGS. 2-6 may be combined, divided, re-arranged, omitted, eliminated and/or implemented in any other way. Further, the example benchmark audience manager 202, the example benchmark audience database 204, the example brand audience manager 206, the example brand audience database 208, the example error calculation engine 210, the example index engine 212, the example design factor manager 214, the example probability manager 216, the example heat map engine 218 and/or, more generally, the example consistency evaluator 200 of FIG. 2 may be implemented by hardware, software, firmware and/or any combination of hardware, software and/or firmware. Thus, for example, any of the example benchmark audience manager 202, the example benchmark audience database 204, the example brand audience manager 206, the example brand audience database 208, the example error calculation engine 210, the example index engine 212, the example design factor manager 214, the example probability manager 216, the example heat map engine 218 and/or, more generally, the example consistency evaluator 200 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, benchmark audience manager 202, the example benchmark audience database 204, the example brand audience manager 206, the example brand audience database 208, the example error calculation engine 210, the example index engine 212, the example design factor manager 214, the example probability manager 216, the example heat map engine 218 and/or, more generally, the example consistency evaluator 200 is/are hereby expressly defined to include a tangible computer readable storage device or storage disk such as a memory, a digital versatile disk (DVD), a compact disk (CD), a Blu-ray disk, etc. storing the software and/or firmware. Further still, the example consistency evaluator 200 of FIG. 2 may include one or more elements, processes and/or devices in addition to, or instead of, those illustrated in FIG. 2-6, and/or may include more than one of any or all of the illustrated elements, processes and devices.

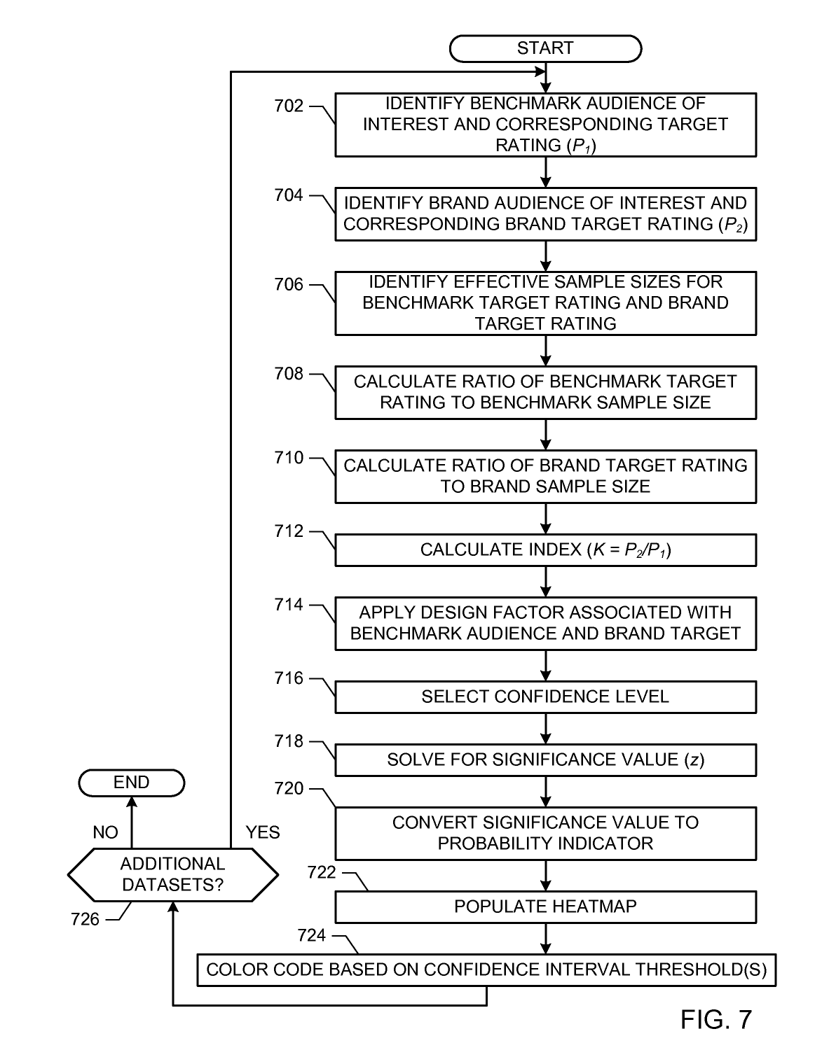

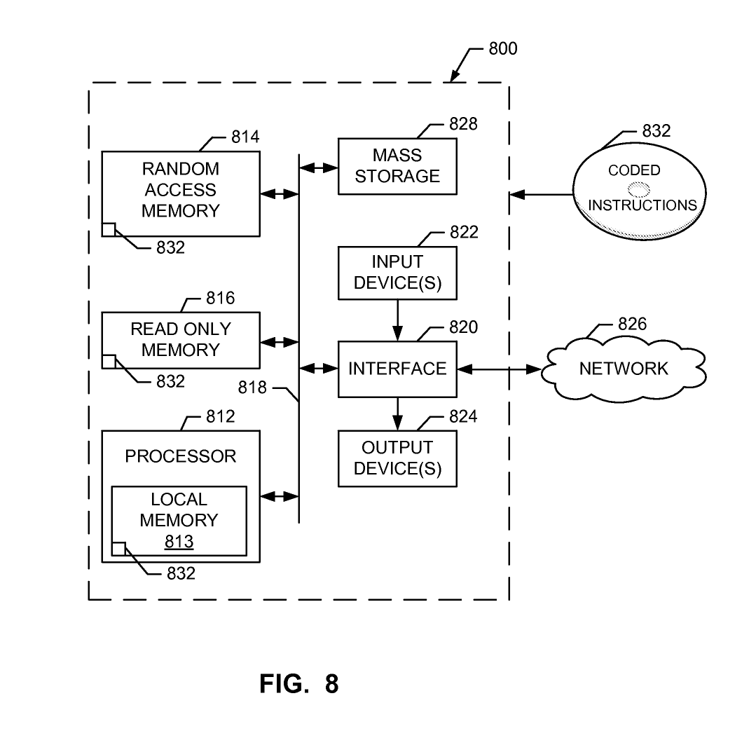

A flowchart representative of example machine readable instructions for implementing the consistency evaluator 200 of FIG. 2 is shown in FIG. 7. In this example, the machine readable instructions comprise a program for execution by a processor such as the processor 812 shown in the example processor platform 800 discussed below in connection with FIG. 8. The program may be embodied in software stored on a tangible computer readable storage medium such as a CD-ROM, a floppy disk, a hard drive, a digital versatile disk (DVD), a Blu-ray disk, or a memory associated with the processor 812, but the entire program and/or parts thereof could alternatively be executed by a device other than the processor 812 and/or embodied in firmware or dedicated hardware. Further, although the example program is described with reference to the flowchart illustrated in FIG. 7, many other methods of implementing the example consistency evaluator 200 may alternatively be used. For example, the order of execution of the blocks may be changed, and/or some of the blocks described may be changed, eliminated, or combined.

As mentioned above, the example processes of FIG. 7 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIG. 7 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disk and to exclude propagating signals. As used herein, when the phrase “at least” is used as the transition term in a preamble of a claim, it is open-ended in the same manner as the term “comprising” is open ended.

The program of FIG. 7 begins at block 702, in which the example benchmark audience manager 202 identifies a benchmark audience of interest and a corresponding target rating value (p₁). As described above, example benchmark audiences may include any type of demographic category such as, for example, men 18-24, women 18-24, etc. The example benchmark audience types are sometimes referred to as standard demographics, which may include one or more standards of consistency (e.g., standard demographics acquired from statistically selected panelists). The example brand audience manager 206 identifies a brand of interest (e.g., a manufacturer's product) and a corresponding brand user rating value (p₂) (block 704). Example audiences associated with the brand of interest may include one or more consistency issues because of their corresponding smaller sample sizes. While the audiences associated with the brand of interest have increased precision in view of a brand of interest, the relatively lower sample sizes may cause a relatively greater degree of variability and/or inconsistency when used alone and/or in combination with benchmark audience data.

The example benchmark audience manager 202 and the example brand audience manager 206 receive and/or otherwise retrieve audience data and corresponding sample sizes associated with the benchmark target rating values and the brand user rating values (block 706). The example error calculation engine 210 calculates a ratio of the benchmark target rating to the benchmark sample size (block 708). As described above, the example error calculation engine 210 may calculate the ratio in a manner consistent with example Equation 2. The example error calculation engine 210 also calculates a ratio of the brand user rating to the brand sample size (block 710). As described above, the example error calculation engine 210 may calculate the ratio in a manner consistent with example Equation 3.

The example index engine 212 calculates an index value (k) based on the ratio of the brand user rating (p₂) and the benchmark target rating (p₁) (block 712). One or more different scenarios of the example benchmark data and/or the brand audience (target) data may occur, which may be mathematically represented by a design effect value (d). The example design factor manager 214 retrieves one or more design factor values, such as design factor values defined and/or otherwise developed by the market analyst(s), and applies them to the benchmark audience and brand user audience values (block 714). One or more significance confidence levels are applied by the example probability manager 216 to consider confidence levels commonly applied to statistical analysis (e.g., 90%, 95%, 99%) (block 716). As described above, one or more confidence levels may be considered and/or otherwise calculated in connection with example Equation 8, which may serve as a basis to solve for the significance value (z), the index (k) and/or a standard error (S) (block 718).

In the event the significance value (z) is calculated by the example probability manager 216 (block 718), the z-value may be converted to a probability indicator in connection with the confidence level of interest (block 720). As described above in connection with example Equation 11, the example probability manager calculates any number of significance values for one or more scenarios (e.g., different design effect values, different brand user index values, different brand user rating values, different effective sample sizes, etc.) (block 720), and the example heat map engine 218 generates one or more corresponding heat maps (block 722). The example heat map engine 218 may apply one or more color codes to resulting values based on one or more threshold values, such as threshold values associated with confidence intervals (block 724). If additional datasets of benchmark audience data and/or brand audience data are available (block 726) (e.g., available in the example benchmark audience database 204 and/or the example brand audience database 208), then control returns to block 702.

One or more iterations may occur to calculate one or more consistency values for datasets (block 726). For example, a first iteration may identify information related to consistency (e.g., z-score value) for a first combination of benchmark data and brand user data, both of which may be associated with a media vehicle (e.g., a television show, a newspaper). In some examples, the consistency values may be calculated in connection with one or more types of brand user datasets having different effective sample sizes, different brand user ratings, different brand user index values and/or different design effect values to allow the market researcher to determine which marketing choices are more likely to result in consistency during one or more subsequent periods.

FIG. 8 is a block diagram of an example processor platform 800 capable of executing the instructions of FIG. 7 to implement the consistency manager 200 of FIG. 2. The processor platform 8000 can be, for example, a server, a personal computer, a mobile device (e.g., a cell phone, a smart phone, a tablet such as an iPad™), a personal digital assistant (PDA), an Internet appliance, or any other type of computing device.

The processor platform 800 of the illustrated example includes a processor 812. The processor 812 of the illustrated example is hardware. For example, the processor 812 can be implemented by one or more integrated circuits, logic circuits, microprocessors or controllers from any desired family or manufacturer.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), and/or a PCI express interface.

In the illustrated example, one or more input devices 822 are connected to the interface circuit 820. The input device(s) 822 permit(s) a user to enter data and commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 820 of the illustrated example, thus, typically includes a graphics driver card, a graphics driver chip or a graphics driver processor.

The interface circuit 820 of the illustrated example also includes a communication device such as a transmitter, a receiver, a transceiver, a modem and/or network interface card to facilitate exchange of data with external machines (e.g., computing devices of any kind) via a network 826 (e.g., an Ethernet connection, a digital subscriber line (DSL), a telephone line, coaxial cable, a cellular telephone system, etc.).

The processor platform 800 of the illustrated example also includes one or more mass storage devices 828 for storing software and/or data. Examples of such mass storage devices 828 include floppy disk drives, hard drive disks, compact disk drives, Blu-ray disk drives, RAID systems, and digital versatile disk (DVD) drives.

The coded instructions 832 of FIG. 7 may be stored in the mass storage device 828, in the volatile memory 814, in the non-volatile memory 816, and/or on a removable tangible computer readable storage medium such as a CD or DVD.

Disclosed example methods, systems apparatus and articles of manufacture allow a market analyst to utilize brand user data having substantially smaller sample sizes while determining a corresponding reduction in predictive consistency that is typically caused by such smaller sample sizes when compared to standard demographics data.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method to calculate an index consistency, comprising:
selecting a first benchmark audience rating and a first brand user rating;
calculating a first ratio of the first benchmark audience rating and a first benchmark audience effective sample size;
calculating a second ratio of the first brand user rating and a brand user effective sample size;
calculating a standard error based on the first and second ratios and an index based on the first benchmark audience rating and the first brand user rating; and
calculating a first consistency value based on the standard error.

2. A method as defined in claim 1, further comprising applying a design effect value when calculating the first consistency value, the design effect value based on an interval duration of the first brand user rating.

3. A method as defined in claim 1, further comprising applying a design effect value when calculating the first consistency value, the design effect value based on a degree of interlacing between the first brand user rating and the first benchmark audience rating.

4. A method as defined in claim 1, wherein the first consistency value is derived from a significance value.

5. A method as defined in claim 4, wherein the significance value is associated with a confidence interval.

6. A method as defined in claim 1, further comprising selecting a second benchmark audience rating to calculate a second consistency value associated with the first brand user rating.

7. A method as defined in claim 6, further comprising selecting a media vehicle based on a comparison between the first and second consistency values.

8. A method as defined in claim 1, further comprising generating a heatmap to compare the first consistency value with a plurality of second consistency values associated with second brand user ratings.

9. A method as defined in claim 1, further comprising calculating a second consistency value based on a second brand user effective sample size.

10. An apparatus to calculate an index consistency, comprising:
an audience manager to select a first benchmark audience rating and a first brand user rating;
an error calculation engine to:
calculate a first ratio of the first benchmark audience rating and a first benchmark audience effective sample size; and
calculate a second ratio of the first brand user rating and a brand user effective sample size;
an index engine to calculate a standard error based on the first and second ratios and an index based on the first benchmark audience rating and the first brand user rating; and
a probability manager to calculate a first consistency value based on the standard error.

11. An apparatus as defined in claim 10, further comprising a design factor manager to apply a design effect value when calculating the first consistency value, the design effect value based on an interval duration of the first brand user rating.

12. An apparatus as defined in claim 10, further comprising a design factor manager to apply a design effect value when calculating the first consistency value, the design effect value based on a degree of interlacing between the first brand user rating and the first benchmark audience rating.

13. An apparatus as defined in claim 10, wherein the probability manager is to derive the first consistency value based on a significance value.

14. An apparatus as defined in claim 13, wherein the probability manager to to associate the significance value with a confidence interval.

15. An apparatus as defined in claim 10, wherein the audience manager is to select a second benchmark audience rating to calculate a second consistency value associated with the first brand user rating.

16. An apparatus as defined in claim 15, further comprising a consistency evaluator to select a media vehicle based on a comparison between the first and second consistency values.

17. An apparatus as defined in claim 10, further comprising a heat map engine to generate a heat map to compare the first consistency value with a plurality of second consistency values associated with second brand user ratings.

18. A tangible machine-readable storage medium comprising instructions stored thereon that, when executed, cause a machine to, at least:
select a first benchmark audience rating and a first brand user rating;
calculate a first ratio of the first benchmark audience rating and a first benchmark audience effective sample size;
calculate a second ratio of the first brand user rating and a brand user effective sample size;
calculate a standard error based on the first and second ratios and an index based on the first benchmark audience rating and the first brand user rating; and
calculate a first consistency value based on the standard error.

19. A machine readable storage medium as defined in claim 18, wherein the instructions, when executed, cause the machine to apply a design effect value when calculating the first consistency value, the design effect value based on an interval duration of the first brand user rating.

20. A machine readable storage medium as defined in claim 18, wherein the instructions, when executed, cause the machine to apply a design effect value when calculating the first consistency value, the design effect value based on a degree of interlacing between the first brand user rating and the first benchmark audience rating.

21. A machine readable storage medium as defined in claim 18, wherein the instructions, when executed, cause the machine to derive the first consistency value from a significance value.

22. A machine readable storage medium as defined in claim 21, wherein the instructions, when executed, cause the machine to associate the significance value with a confidence interval.

23. A machine readable storage medium as defined in claim 18, wherein the instructions, when executed, cause the machine to select a second benchmark audience rating to calculate a second consistency value associated with the first brand user rating.

24. A machine readable storage medium as defined in claim 23, wherein the instructions, when executed, cause the machine to select a media vehicle based on a comparison between the first and second consistency values.

25. A machine readable storage medium as defined in claim 18, wherein the instructions, when executed, cause the machine to generate a heat map to compare the first consistency value with a plurality of second consistency values associated with second brand user ratings.

26. A machine readable storage medium as defined in claim 18, wherein the instructions, when executed, cause the machine to calculate a second consistency value based on a second brand user effective sample size.
